(19) United States
(12) Patent Application Publication
(10) Pub. No.: US 2013/0240304 A1
(43) Pub. Date: Sep. 19, 2013

(54) LOW CONDUCTIVITY BRAKE PAD

(71) Applicant: Michael G. McCaffrey, Windsor, CT (US)

(72) Inventor: Michael G. McCaffrey, Windsor, CT (US)

(73) Assignee: UNITED TECHNOLOGIES CORPORATION, Hartford, CT (US)

(21) Appl. No.: 13/423,757

(22) Filed: Mar. 19, 2012

(51) Int. Cl. F16D 55/225; F16D 65/092; F16J 1/01; F16D 65/84

(52) U.S. Cl. 188/72.4; 188/251 R; 188/251 A; 92/248

(57) ABSTRACT

A multi-layer brake pad assembly includes a layer of friction material, a layer of thermal insulating material, and a backing plate. The thermal insulating material is a fiber reinforced ceramic matrix composite with a high fracture toughness and low thermal conductivity that is disposed between the friction material and the backing plate and restricts the heat flow transmitted through the backing plate into the hydraulic fluid during severe braking, thereby minimizing the onset of brake loss due to hydraulic fluid vaporization as a result of overheating.

### BACKGROUND

This invention relates to brake systems used to control the motion of vehicles under severe conditions such as high speed operation and braking.

During high speed braking, a hydraulic piston contacts a brake pad under a high load generating considerable frictional heat which is transmitted through the brake pad into the underlying piston. Under severe conditions, such as in competition driving and heavy vehicle or aircraft braking, the frequency and duration of brake application increases to the point where the heat input into the piston exceeds the ability of the brake assembly to dissipate the heat and prevent the heat from being transmitted through the piston to the hydraulic system. In this situation, the fluid temperature approaches a point where the fluid begins to boil, creating a compressible gas wherein brake pressure is lost and braking is compromised. In extreme cases, the brake pedal can reach its displacement limit, braking control is lost, and a dangerous situation develops.

Efforts to minimize overheating in braking systems are ongoing. Material or engineering improvements to minimize the transmission of heat from the friction surface to the hydraulic fluid system would be beneficial.

### SUMMARY

A multilayer brake assembly includes a caliper, multilayer brake pads and a hydraulic cylinder assembly. The multilayer brake pads consist of a fiber reinforced ceramic matrix composite thermal insulating material positioned between a layer of friction material and a backing layer. A piston in the cylinder assembly acts to push the brake pads against a rotor in a braking event.

Another embodiment is a multilayer brake pad assembly that includes a layer of fiber reinforced ceramic matrix composite thermal insulating material between a layer of friction material and a layer of backing material to reduce the transfer of heat from the friction layer to the backing material.

Another embodiment is a piston in a brake assembly formed of a fiber reinforced ceramic matrix composite thermal insulating material.

### BRIEF DESCRIPTION OF THE DRAWINGS

FIG. 1 is a schematic showing the components of a disc brake system.

FIG. 2 is a schematic showing the components of a multi-layer brake pad assembly.

FIG. 3 is a schematic showing the structural details of a thermal insulating layer.

### DETAILED DESCRIPTION

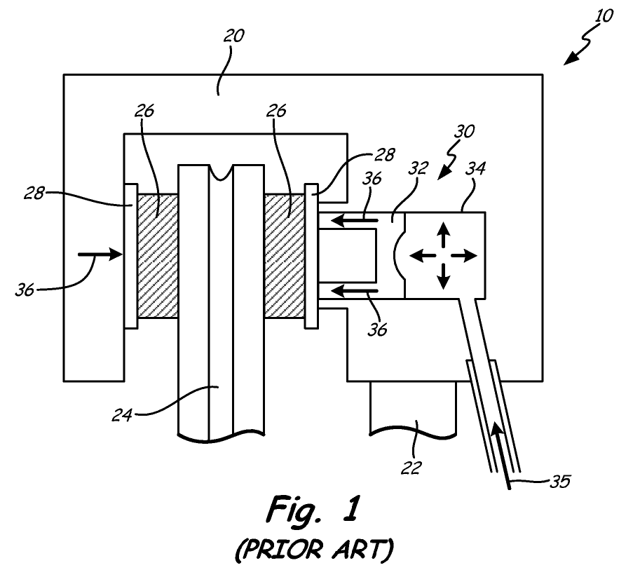

The invention addresses the problem of brake overheating by installing a thermal insulator in the thermal circuit between the friction material and the steel backing plate of a disc brake pad, thereby decreasing the chances of hydraulic fluid overheating and boiling during high performance braking. A schematic of a prior art disc brake system for a vehicle is shown in FIG. 1. Disc brake system 10 comprises caliper 20 mounted on the vehicle by mounting support 22 supporting brake pads 26, backing plates 28, and piston assembly 30. Piston assembly 30 comprises piston 32 and hydraulic cylinder 34. Hydraulic cylinder 34 contains hydraulic fluid supplied by a master cylinder, not shown, but indicated by arrow 35. Rotor 24 is attached to a wheel, not shown, of a vehicle.

During a braking event, a pedal, not shown, applies pressure to a master cylinder that increases pressure in cylinder 34. Piston 32 responds by pressing brake pads 26 against rotor 24. The braking pressure, as indicated by arrows 36, creates friction energy that slows the rotational velocity of rotor 24 attached to a wheel of the vehicle, and thereby slows or stops the vehicle.

Disc brake system 10 may be taken as a representative friction brake system employed on vehicles in general. Examples include cars, trucks, trains, and aircraft.

A major design factor in all friction braking systems is the management of the heat generated during the braking process. Friction materials are designed to withstand high temperatures while maintaining an acceptable coefficient of friction and fracture strength. Brake systems are designed to dissipate the heat generated at the braking interfaces by channeling air flow over the pads, by introducing internal cooling passages and external fins into the rotor design and by employing high temperature and high strength materials in the rotors and brake pads. As an example, most rotors on high performance cars are cross-drilled to improve cooling air flow.

Friction material development in the art has focused on materials possessing high strength and friction coefficients at elevated temperatures. Friction materials may be polymer, metal, or ceramic matrix composites containing at least one hard friction material. The friction material may be a continuous fiber, a discrete fiber, or other particulate forms. Furthermore, the fibers may be in continuous or yarn form. Most, if not all, friction materials for brake discs and pads are commercially available proprietary formulations. Emphasis on high temperature performance has directed development to ceramic matrix materials containing friction producing elements such as fibers. An example of recent prior art braking friction materials is described in U.S. Pat. No. 5,806,636 to Atmur et al. and incorporated herein as reference. The brake materials described are a family of fiber reinforced ceramic matrix composite (FRCMC) materials with high fracture resistance and high temperature stability. The fibers provide the friction component. Several ceramic matrix compositions are polymer derived and commercially available such as silicon-carboxyl resin (sold as Allied Signal Blackglas) and alumina silicate resin (Applied Polymerics C02) combined with fiber systems such as Nextel 312, Nextel 550, silicon nitride, silicon carbide, graphite, carbon, and others.

Before the fibers are consolidated, they are first coated with an interface material such as silicon nitride, silicon carbide, or boron nitride to allow partial separation between the matrix and fibers after firing to allow fiber pullout during fracture if the material is overloaded during use. The brake parts are produced by first mixing polymer resin with the coated fiber system. Alumina or mullite powder is then added for additional wear resistance. The resin mixture is then formed into a part and fired to about 1800° F. (982° C.) to convert the mixture into a FRCMC. Wear resistance in completed parts is improved by aligning fibers in the vicinity of the near surface region of the part during lay-up.

The above prior art material is an example of state of the art brake materials with high temperature resistance, good thermal conductivity, good braking friction due to the fiber content, and wear resistance due to the ceramic additions. Most large aircraft braking systems and braking systems in high performance race cars use carbon/carbon composite friction materials such as the ones described above.

Other braking materials in the art comprise organic and inorganic based matrix composites containing metal fibers, organic and inorganic fibers, and other abrasives, as well as modifiers such as glass, rubber, minerals, and lubricants, and mixtures thereof. All breaking materials need fracture toughness values sufficient to resist fracture under loads experienced in hard braking conditions.

As noted above, frictional heating is an important issue with braking systems in high performance applications. Heat may be transmitted through brake pads 26, backing plates 28, and piston 32 into cylinder 34 to heat hydraulic fluid. If the heating is excessive, braking efficiency may be degraded. The present invention is an improved brake pad assembly with a thermal barrier. The thermal barrier restricts thermal flow toward hydraulic cylinder 34 while allowing lateral heat flow to escape the system. The thermal barrier has bimodal thermal conductivity. The thermal conductivity in a longitudinal direction toward piston 32 and cylinder 34 is lower than the thermal conductivity in a lateral direction towards the sides of the brake pad assembly.

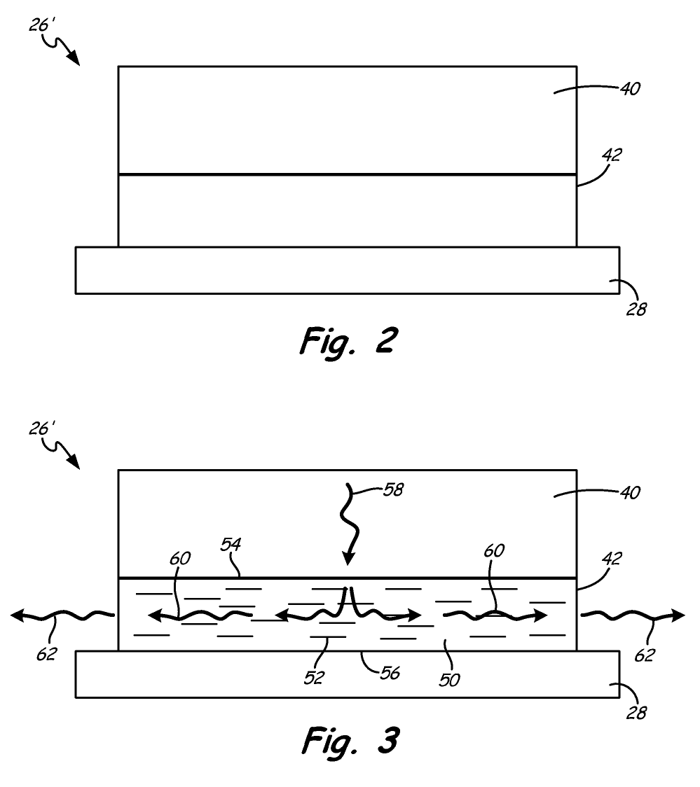

A schematic of inventive brake pad 26′ is shown in FIG. 2. Brake pad 26′ comprises thermal insulating layer 42 between friction layer 40 and backing plate 28. In an embodiment, piston 32 can be formed from thermal insulating material 42 to further restrict thermal flow to cylinder 34.

Friction layer 40 comprises a friction material known to those in the art. An example of the material of friction layer 40 is the FRCMC material described above, comprising, for instance, carbon fiber reinforced, polymer precursor carbon matrix containing a ceramic addition to reduce wear. Backing plate 28 may be steel as described above.

Friction layer 40, thermal insulating layer 42 and backing plate 28 may be bonded to each other by mechanical means, by adhesive or chemical means, or by other attachment means known in the art. Providing proper lateral restraint exists such as, for example, a steel container supporting the lateral surface of inventive brake pad 26′, friction material 40 and thermal insulating layer 42, need not be bonded to each other.

Thermal insulating layer 42 may be a fiber reinforced ceramic matrix composite (FRCMC) material with a high fracture toughness and low thermal conductivity. In an embodiment, insulating layer 42 may have anisotropic thermal conductivity wherein the thermal conductivity in the short transverse direction, that is, the direction perpendicular to the surface of the layer, is lower than the thermal conductivity in a direction parallel to the top and bottom surfaces of thermal insulating layer 42.

A schematic showing the structural details of FRCMC thermal insulating layer 42 of the invention with anisotropic thermal conductivity is shown in FIG. 3. Thermal insulating layer 42 comprises matrix 50 and fibers 52. Matrix 50 has a lower thermal conductivity than fibers 52. By way of comparison, matrix 50 may be a thermal insulator and fibers 52 may be thermal conductors. FRCMC thermal insulating layer 42 is formed with fibers 52 oriented predominantly in a direction parallel to major surfaces 54 and 56 respectively of thermal insulating layer 42 as shown. The mass loading and thermal conductivity of fibers 52 are sufficient to divert heat flow from friction layer 40, indicated by curved arrow 58, from a direction perpendicular to major surfaces 54 and 56 to directions parallel to the surfaces as indicated by arrows 60. Schematic arrows 62 indicate heat flow leaving thermal insulator 42. The anisotropic thermal conductivity will exit the braking system by radiation and conduction, thereby limiting heat flow to piston 32 and cylinder 34.

The thermal insulating layers of the invention comprise, in general, fiber reinforced ceramic matrix composites. The matrix thermal conductivity of thermal insulating layer 42 is suggested to be less than conventional ceramic materials such as oxide, nitride, and carbide ceramics. As a benchmark, the thermal conductivities of polycrystalline aluminum oxide, silicon carbide, silicon nitride, and boron nitride are about 0.30 W/cmK, 0.14 W/cmK, 0.24 W/cmK, and 0.25 W/cmK respectively. According to the invention, the thermal conductivity of the ceramic matrix may be from about 0.01 W/cmK to 0.05 W/cmK. Ceramic materials with thermal conductivities in this range are mainly confined to the families of glasses and glass-ceramics. For example, the thermal conductivities of fused silica, sodalime glass, and pyrex glass, are 0.015 W/cmK, 0.015 W/cmK, and 0.010 W/cmK, respectively an order of magnitude lower than those of ceramic materials quoted above. The thermal conductivities of silicate based glass-ceramics are about the same as the glasses. In an embodiment, thermal insulating layer 42 is a fiber reinforced glass or glass-ceramic matrix composite wherein the matrix may be a silicate glass or glass-ceramic with a thermal conductivity from about 0.01 W/cmK to 0.05 W/cmK. The fibers may be ceramic fibers with thermal conductivities exceeding that of the matrix. As a result, the anisotropic thermal conductivity of thermal insulating layer 42 may be controlled, if necessary, by the geometrical distribution of the fiber load in the matrix in thermal insulating layer 42. For example, if the thermal conductivity in the plane of layer 42 is designed to be greater than that in the short transverse direction perpendicular to the plane, it is advantageous that the fibers have a length that is a significant fraction of the thickness of layer 42 and that the majority of the fibers are oriented parallel to the plane of layer 42. In a FRCMC material with the above mentioned internal structure, part of the heat flux in the layer from friction layer 40 under extreme braking conditions will be directed toward the outside edges of the layer away from the backing plate and components beneath it as suggested by FIG. 3.

Procedures to produce FRCMC thermal insulating layers with predesigned geometric fiber loading to produce materials with anisotropic thermal conductivities such as the example described above, are known in the art and can be applied to produce the insulating material of the present invention.

The thermal conductivities of fibers in the FRCMC friction material of this invention are advantageously greater than the glass and glass-ceramic matrices of the invention. As an example, the thermal conductivities of silicon carbide fibers and graphite fibers known in the art exceed 0.4 W/cmK and 1.0 W/cmK respectively.

In the 1980s and 1990s, a series of fiber reinforced ceramic matrix composites (FRCMC) were developed by United Technologies Corporation are that. A number of these materials can be used to advantage in the present invention. The Compglas® composites comprised glass or glass-ceramic matrices containing carbon or silicon carbide fibers. Mechanical properties and thermal resistance were exceptional. Exemplary matrix materials included borosilicate glass, high silicon content glass, aluminosilicate glass, and lithium aluminosilicate glass-ceramic. Thermal stability to temperatures greater than 1800° F. (982° C.) and flexural strengths to values greater than 300 MPa were achieved. In an embodiment, Compglas® and similar materials with anisotropic fiber orientation are candidates for application as thermal insulating layer 42.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

### DISCUSSION OF POSSIBLE EMBODIMENTS

The following are non-exclusive descriptions of possible embodiments of the present invention.

A brake assembly can be attached to a vehicle frame to engage a rotor attached to a vehicle wheel during a braking event. The brake assembly can include a caliper, multilayer brake pads supported by the caliper and a backing layer. The brake pads are comprised of a thermal insulating layer of fiber reinforced ceramic matrix composite thermal insulating material in contact with and positioned behind a layer of friction material. A hydraulic cylinder assembly is supported by the caliper and comprises a piston movable within a hydraulic cylinder to forcibly push the brake pads against the rotor to frictionally engage the rotor during a braking event.

The assembly of the preceding paragraph can optionally include, additionally and/or alternatively any one or more of the following features, configurations, and/or additional components:
the ceramic matrix composite can be a low thermal conductivity glass or glass-ceramic matrix material;
the ceramic matrix composite may have a thermal conductivity of from about 0.01 W/cmK to about 0.05 W/cmK;
the ceramic matrix composite may be at least one of borosilicate glass, magnesium aluminosilicate glass, lithium aluminosilicate glass, and barium magnesium aluminosilicate glass-ceramic;
the fiber reinforcement of the ceramic matrix composite may comprise continuous or discrete fibers in monofilament or yarn form;
the fibers of the ceramic matrix may comprise carbon, graphite, or silicon carbide fibers;
the thermal conductivity of the silicon carbide and graphite fibers of the ceramic matrix composite may exceed 0.4 W/cmK and 1.0 W/cmK respectively;
a majority of the fibers in the fiber reinforced ceramic matrix composite may be oriented parallel to the brake pad surface;
the ceramic matrix composite may have a thermal conductivity in a direction parallel to the brake pad surface that exceeds the thermal conductivity in a direction perpendicular to the brake pad surface;
the brake assembly may have friction material that comprises fiber reinforced ceramic matrix composite thermal insulating materials;
the brake assembly may have a piston that comprises fiber reinforced ceramic matrix composite thermal insulating material.

A multilayer brake pad assembly may comprise a friction layer of friction material, a backing layer, and a thermal insulating layer of a fiber reinforced ceramic matrix composite material positioned between the friction layer and the backing layer of the assembly.

The assembly of the preceding paragraph can optionally include, additionally and/or alternatively any one or more of the following features, configurations, and/or additional components:
the ceramic matrix composite of the brake pad assembly of the preceding paragraph may be a low thermal conductivity glass or glass-ceramic;
the fiber reinforcement of the thermal insulating layer of the brake pad assembly may comprise continuous or discrete fibers in monofilament or yarn form;
the fibers in the brake pad assembly may comprise carbon, graphite, or silicon carbide fibers;
the majority of the fibers in the brake pad assembly may be oriented parallel to the brake pad surface and perpendicular to the short transverse direction of the pad;
the thermal conductivity of the fiber reinforced thermal insulating layer may be higher in a direction parallel to the pad surface than in a direction perpendicular to the pad surface.

A brake pad assembly may comprise a piston and a brake pad moveable by the piston wherein at least one of the brake pad and the piston comprise a fiber reinforced ceramic matrix composite thermal insulating material.

The assembly of the preceding paragraph can optionally include, additionally and/or alternatively any one or more of the following features, configurations, and/or additional components:
the ceramic matrix composite thermal insulating material of the previous paragraphs may be a low thermal conductivity glass or glass-ceramic matrix;
a piston for use in a brake assembly (including for example the brake assembly of the previous paragraphs) may be formed of a fiber reinforced ceramic matrix composite thermal insulating material.

1. A brake assembly attached to a vehicle frame to engage a rotor attached to a vehicle wheel during a braking event, the brake assembly comprising:
a caliper;
multilayer brake pads supported by the caliper and comprising a thermal insulating layer of fiber reinforced ceramic matrix composite thermal insulating material in contact with and positioned between a layer of friction material and a backing layer; and
a hydraulic cylinder assembly supported by the caliper and comprising a piston movable within a hydraulic cylinder to forceably push the brake pads against the rotor to frictionally engage the rotor during a braking event.

2. The brake assembly of claim 1, wherein the ceramic matrix is a low thermal conductivity glass or glass-ceramic matrix.

3. The brake assembly of claim 2, wherein thermal conductivity of the glass or glass-ceramic matrix is from about 0.01 W/cmK to about 0.05 W/cmK.

4. The brake assembly of claim 2, wherein the ceramic matrix comprises at least one of borosilicate glass, magnesium alumino silicate glass, lithium alumino silicate glass, and barium magnesium alumino silicate glass-ceramic.

5. The brake assembly of claim 1, wherein fiber reinforcement of the ceramic matrix composite comprises continuous or discrete fibers in monofilament or yarn form.

6. The brake assembly of claim 5, wherein the fibers comprise carbon, graphite or silicon carbide fibers.

7. The brake assembly of claim 5, wherein thermal conductivity of the silicon carbide and graphite fibers exceeds 0.4 W/cmK and 1.0 W/cmK respectively.

8. The brake assembly of claim 5, wherein a majority of the fibers are oriented parallel to the pad surface.

9. The brake assembly of claim 8, wherein the thermal conductivity in a direction parallel to the pad surface exceeds the thermal conductivity in a direction perpendicular to the pad surface.

10. The brake assembly of claim 1, wherein the friction material comprises fiber reinforced ceramic matrix composite thermal insulating material.

11. The brake assembly of claim 1, wherein the piston comprises fiber reinforced ceramic matrix composite thermal insulating material.

12. A multilayer brake pad assembly comprising:
a friction layer of friction material;
a backing layer; and
a thermal insulating layer of a fiber reinforced ceramic matrix composite material positioned between the friction layer and the backing layer.

13. The brake pad assembly of claim 12, wherein the ceramic matrix is a low thermal conductivity glass or glass-ceramic.

14. The brake pad assembly of claim 12, wherein the fiber reinforcement comprises continuous or discrete fibers in monofilament or yarn form.

15. The brake pad assembly of claim 14, wherein the fibers comprise carbon, graphite or silicon carbide fibers.

16. The brake pad assembly of claim 14, wherein a majority of the fibers are oriented parallel to the pad surface and perpendicular to the short transverse dimension of the pad.

17. The brake pad assembly of claim 12, wherein thermal conductivity of the thermal insulating layer in a direction parallel to the pad surface exceeds thermal conductivity in a direction perpendicular to the pad surface.

18. A brake pad assembly comprising:
a piston; and
a brake pad movable by the piston wherein at least one of the brake pad and the piston comprises a fiber reinforced ceramic matrix composite thermal insulating material.

19. The brake assembly of claim 18, wherein the ceramic matrix is a low thermal conductivity glass or glass-ceramic matrix.

20. A piston for use in a brake assembly for moving a brake pad into engagement with a rotor during a braking event, the piston being formed of a fiber reinforced ceramic matrix composite thermal insulating material.
